(19) United States
(12) Patent Application Publication
(10) Pub. No.: US 2007/0236583 A1
(43) Pub. Date: Oct. 11, 2007

(54) Automated creation of filenames for digital image files using speech-to-text conversion

(75) Inventors: John Vuong, San Jose, CA (US); Sarah Korah, San Jose, CA (US); Jay R. Keller, Sunnyvale, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/399,931

(22) Filed: Apr. 7, 2006

(51) Int. Cl. H04N 5/76

(52) U.S. Cl. 348/231.99

(57) ABSTRACT

A system and method for automatically generating annotated filenames for digital image files allows users to create meaningful filenames for digital image files captured by a digital camera. After an image is captured by the digital camera, an audio annotation containing audio information is associated with the digital image file. The audio information in the audio annotation is converted to a text string using speech-to-text conversion. The text string is then associated with the digital image file as the annotated filename of the digital image file.

### BACKGROUND OF THE INVENTION

The present invention relates generally to digital cameras including digital still cameras, digital video cameras, mobile telephones having integrated digital cameras, and the like, and more particularly to a system and method for automatically creating meaningful filenames for digital image files using speech-to-text conversion.

Digital cameras capture images electronically and store the images in memory in a digital format as a digital image file such as a digital photograph, video or the like. If desired, these digital image files may then be transferred or downloaded to an image processing device such as a computer, photograph printer, or the like to be edited and/or printed. Many digital cameras further allow users to record a short audio or voice annotation, typically a few seconds in duration, which may then be associated with a given digital image file. Such audio annotations may be utilized by the user for a variety of purposes, such as to provide context to the image or to record information to be used during editing or printing.

Presently, digital cameras employ a default file naming scheme for identifying and tracking digital image files stored in memory or transferred to a digital image processing device such as a computer or digital photograph printer. Typical default file naming schemes used employ a combination of letters and numbers which are sequentially assigned to files stored in the memory of the digital camera. For example, several common naming schemes employ an identifier consisting of a series of letters (e.g., “DSC,” “IMG,” “IMG_,” “PICT,” “DSCF,” “DSCN,” etc.) which are used to indicate the type of digital image file, e.g., photograph, video, or the like, or a series of numbers (“101,” “101_,” etc.) which are used to identify a file or folder partitioned in the memory of the digital camera. A sequence number (e.g., “0001,” “0002,” “0003,” etc.) is appended to this identifier to identify the particular digital image file from other digital image files stored in the memory. Finally, a file type extension (e.g., “JPG,” “TIF,” “BIT,” “MPG,” etc.) may appended to the end of the number to identify the file type of the digital image file. In this manner, a default filename is created having the form “DSC0001.JPG,” “IMG_{—}0001.JPG,” “101_{—}0002,” or the like, which is thereafter used to identify the digital image file.

One problem with such default file naming schemes is that they convey little or no useful information to the user of the digital camera that will help the user distinguish one file from another. Instead, the user must open and view each file to determine if the digital image file contains the image desired. Moreover, many digital cameras employ memories that are capable of storing very large numbers of digital image files, making this process inefficient and frustrating to the user. To address this shortcoming, many digital cameras are capable of displaying thumbnails, which consist of small versions of the image stored by the digital image file. In this manner, the user may select a desired image file without opening files stored in memory. However, the version of the images provided by a thumbnail is usually very small, making it difficult for the user to distinguish between image files containing images of similar subject matter.

Consequently, it would be desirable to provide a system and method for quickly and efficiently creating annotated filenames for digital image files which convey meaningful information to the user, thereby allowing the user to search through and select among digital image files stored in memory and/or classify and organize those files without unnecessarily opening and viewing the files.

### SUMMARY OF THE INVENTION

The present invention is directed to a system and method for automatically generating annotated filenames for digital image files captured by a digital camera, which convey meaningful information to the user. In this manner, the user may create filenames which may be used for more efficiently selecting among digital image files stored in memory, reducing the need for unnecessarily opening and viewing files.

In one specific embodiment, the present invention provides a digital camera capable of automatically generating annotated filenames for digital image files. The digital camera includes an imaging system for capturing an image, a processing system coupled to the imaging system for processing the captured image as a digital image file, and an audio system for recording an audio annotation containing audio information associated with the digital image file. After an image is captured, the processor of the digital camera executes a program of instructions for converting the audio information to a text string and associating the text string with the digital image file as the annotated filename of the digital image file.

In a second specific embodiment, the present invention provides a system and method for automatically generating annotated filenames for digital image files captured by a digital camera. In accordance with the system and method, an audio annotation containing audio information is associated with the digital image file. The audio information in the audio annotation is converted to a text string using speech-to-text conversion. The text string is then associated with the digital image file as the annotated filename of the digital image file.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustrating a digital camera in accordance with an exemplary embodiment of the present invention;

FIG. 2 is a block diagram illustrating generation of an annotated filename for a digital image file in the digital camera shown in FIG. 1;

FIGS. 3A, 3B and 3C are diagrammatic views illustrating the display of the digital camera shown in FIG. 1 during generation of annotated filenames for digital image files stored in memory by the digital camera;

FIG. 4 is a flow diagram illustrating a method for generating an annotated filename for a digital image file in accordance with an exemplary embodiment of the present invention;

FIG. 5 is a block diagram illustrating a digital camera in accordance with a second exemplary embodiment of the present invention;

FIG. 6 is a block diagram illustrating generation of an annotated filename for a digital image file in the digital camera shown in FIG. 5;

FIGS. 7A and 7B are diagrammatic views illustrating the display of the digital camera shown in FIG. 5 during naming of a digital image file being stored in memory by the digital camera;

FIG. 8 is a flow diagram illustrating a method for generating an annotated filename for a digital image file in accordance with a second exemplary embodiment of the present invention; and

FIG. 9 is a block diagram illustrating a digital camera in accordance with the present invention coupled to an image processing device, wherein the generation of annotated filenames for digital image files captured by the digital camera is provided by the image processing device.

### DETAILED DESCRIPTION OF SPECIFIC EMBODIMENTS

Reference will now be made in detail to the presently preferred embodiments of the invention, examples of which are illustrated in the accompanying drawings.

FIGS. 1 through 12 illustrate systems and methods for automatically generating annotated filenames for digital image files captured by a digital camera, which convey meaningful information to the user in accordance with exemplary embodiments of the present invention.

FIG. 1 depicts an exemplary digital camera 100 in which the system and method of the present invention may be implemented. As shown, the digital camera includes an imaging system 102 having a lens/shutter assembly 104 which directs and focuses light onto an imager 106 comprised of one or more CCD (Charge-Coupled Device) or a CMOS (Complementary Metal-Oxide Semiconductor) sensors for capturing images of a subject. The lens/shutter assembly 104 and imager 106 are coupled to a processing system 108 which controls operation of the shutter and lenses of the lens/shutter assembly and processes image information received from the imager 106 to generate a digital image file containing the captured image in a digital format. In exemplary embodiments, the processing system 108 may include a processor, memory such as Random Access Memory (RAM), Read Only Memory (ROM), Electrically Erasable Programmable Read Only Memory (EEPROM), or the like, a bus system, and the like, as required for operation of the digital camera 100. The processing system 108 is coupled to a memory 110 for storing the digital image file. In exemplary embodiments, the memory 110 may comprise a FLASH memory such as Compact Flash, SmartMedia®, PC Card, Memory Stick®, Memory Stick® Duo, and the like; a hard disk drive; a removable disk drive; or the like. The digital camera 100 may further include a display 112 coupled to the processing system 108 for displaying the image to be captured to the user, thereby allowing the user to center the image, focus the digital camera 100, pose persons appearing in the image, and the like. The display 112 may further be used to display captured images retrieved from image files, menus for conveying information to the user, selecting features of the digital camera 100 for controlling operation of the digital camera 100, and the like. The digital camera further includes an audio system 114 including a microphone 116, and optionally, a speaker 118, for allowing a user to record a short audio or voice annotation, record sound for digital video recording, input voice commands, and the like.

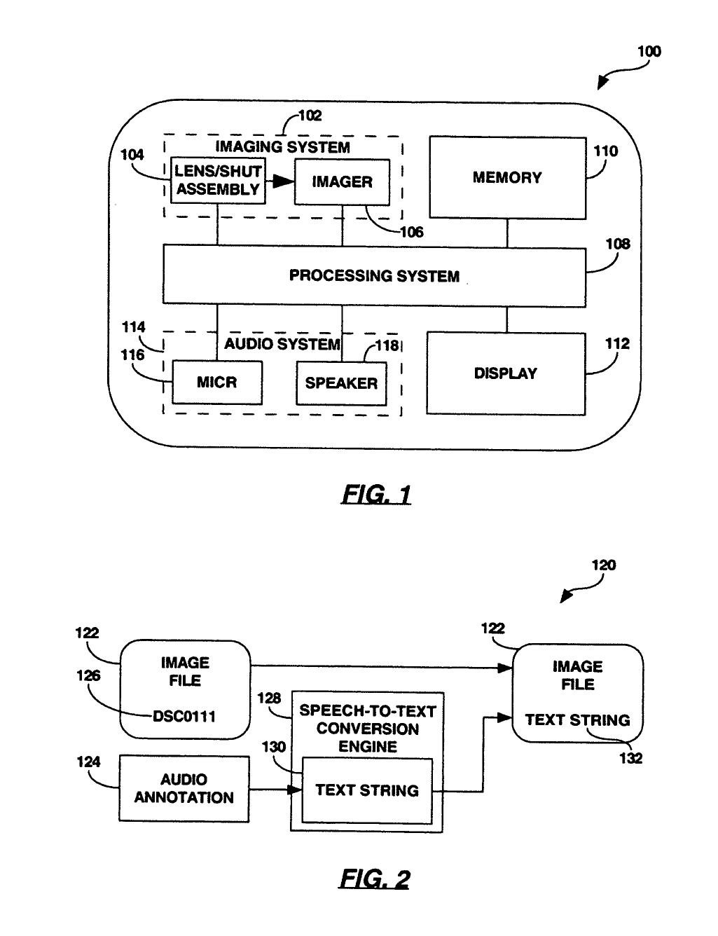

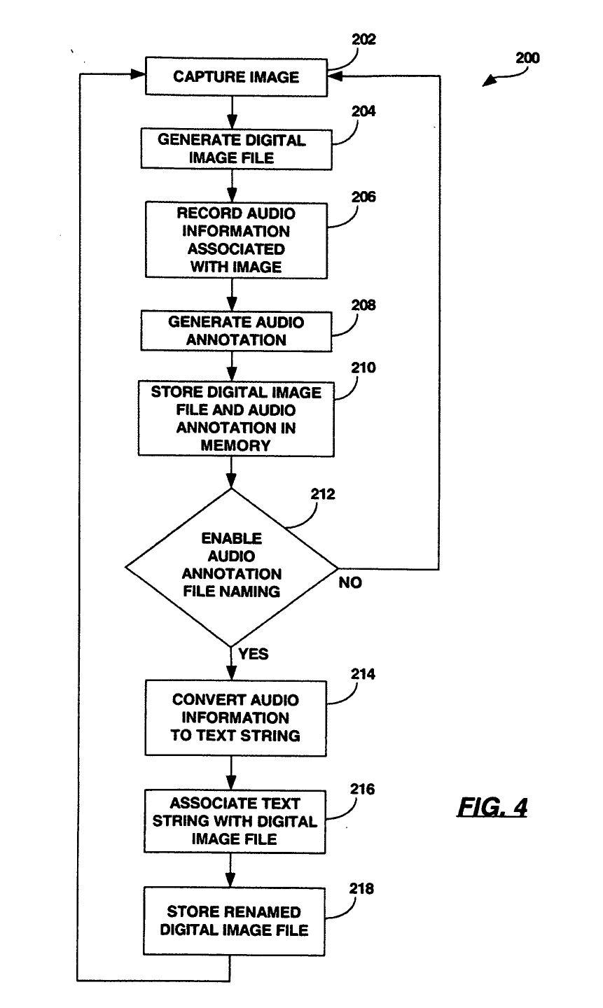

As shown in FIG. 2, the digital camera 100, shown in FIG. 1, employs a system 120 for automatically generating annotated filenames for digital image files in accordance with an exemplary embodiment of the present invention. An image or images are captured by the imaging system 102 of the digital camera 100 and stored in memory 110 as a digital image file 122. In embodiments of the invention, the digital image file 122 may comprise a digital still photograph containing a single photographic image or a group of photographic images, a digital video, or the like, employing a common format such the formats specified by the Joint Photographic Experts Group (JPEG), the Moving Picture Experts Group (MPEG), or the like.

The user may further generate an audio annotation 124 associated with the digital image file 122 by recording audio or voice information using the audio system 112 of the digital camera 100. This feature allows the user to provide context to captured images or to record information to be used later during editing or printing of images. When recorded, the audio annotation is associated with the digital image file 122, and stored with the digital image file 122 in memory 110. For instance, in one embodiment, after a photographic image is captured, the digital camera 100 may prompt the user (e.g., via a prompt displayed by the display 112) to record an audio annotation 124. The user may then speak into the microphone 116 of the audio system 114 to record an audio annotation 124, which is typically a few seconds in duration.

When the digital image file 122 and any associated audio annotation 124 are stored to memory 110, the processing system 108 executes a program of instructions which assigns an initial default filename 126 to the digital image file 122. Default file naming schemes which may be used by digital cameras such as the digital camera 100 illustrated in FIGS. 1 and 2 typically employ a combination of letters and numbers which are sequentially assigned to files stored in the memory 110 of the digital camera 100. For example, the default file naming scheme employ an identifier consisting of a series of letters (e.g., “DSC,” “IMG,” “IMG_,” “PICT,” “DSCF,” “DSCN,” etc.) which are used to indicate the type of digital image file, e.g., photograph, digital video, or the like, or a series of numbers (“101,” “101_,” etc.) which are used to identify a file or folder partitioned in the memory of the digital camera 100. A sequence number (e.g., “0001,” “0002,” “0003,” etc.) is appended to this identifier to identify the particular digital image file from other digital image files stored in the memory. Finally, a file type extension (e.g., “.JPG,” “.TIF,” “.BIT,” “.MPG,” etc.) may appended to the end of the number to identify the file type of the digital image file. In the embodiment illustrated in FIG. 2, the default filename 126 assigned comprises the string “DSC0111” which employs the identifier “DSC” coupled with the sequence number “0111.” However, it will be appreciated that the processing system 108 may assign filenames having other formats without departing from the scope and intent of the present invention.

In accordance with the present invention, the user may choose to create an annotated filename for digital image files 122 already stored in memory 110 of the digital camera using the audio annotations 124 associated with the digital image file 122. In such instances, a speech-to-text conversion engine 128 automatically converts the audio information contained in the audio annotation 124 for each digital image file 122 having an associated audio annotation 124 to a text string 130 using a speech-to-text conversion routine. The speech-to-text conversion engine 128 then replaces the default filenames 126 of the digital image files 122 with the text string 130 and stores the digital image file 122 in memory 110 so that the text string 130 is associated with the digital image file 122 as the annotated filename 132 of the digital image file 122.

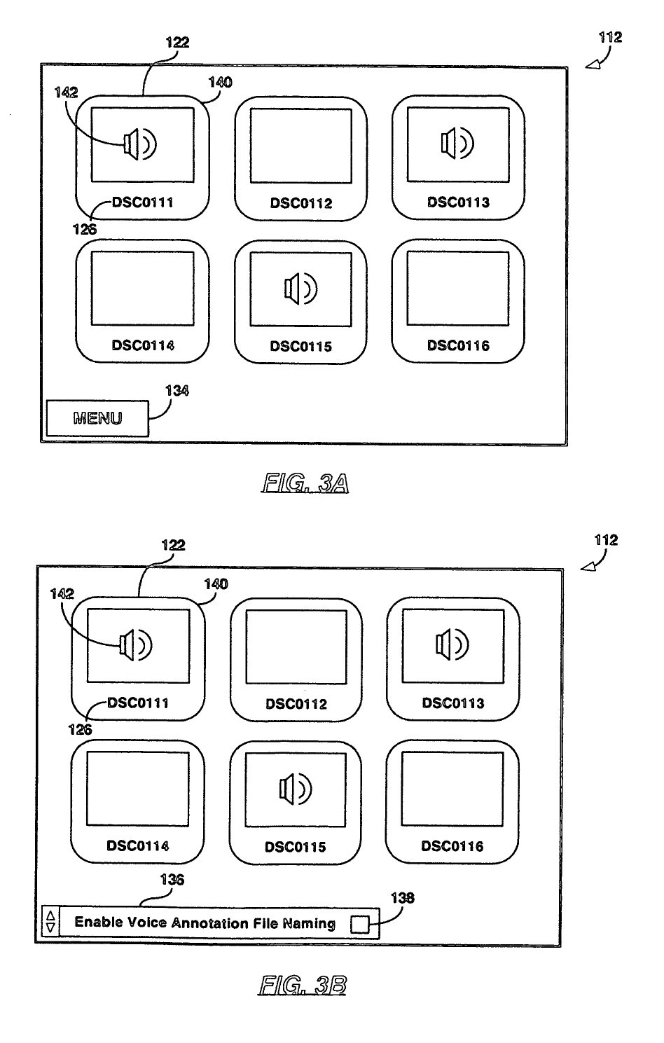

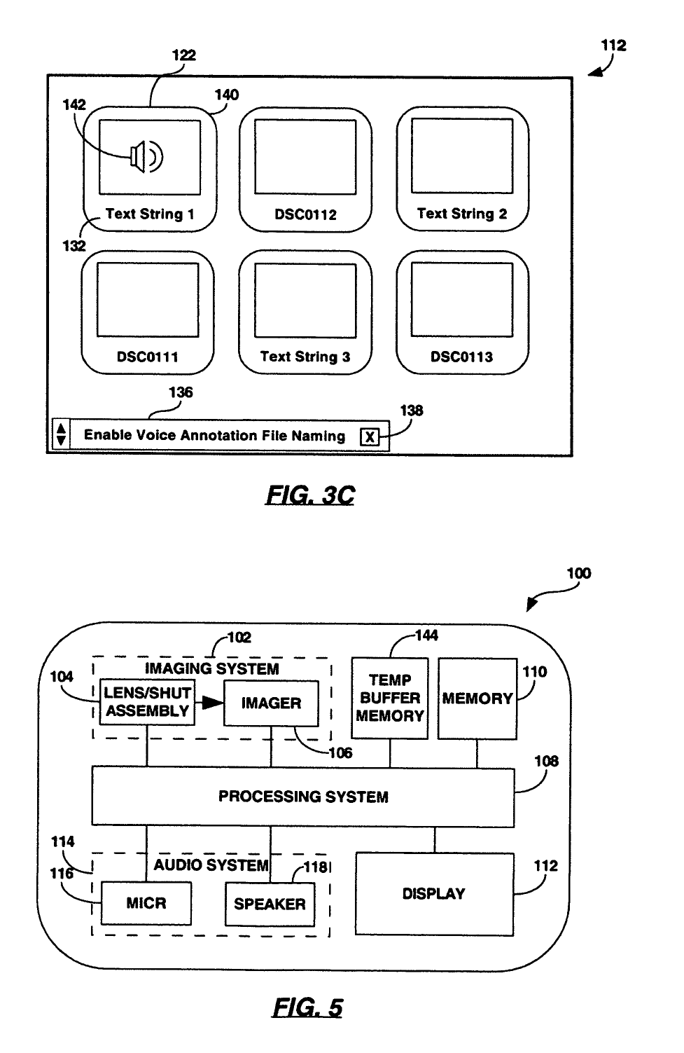

For example, in the embodiment shown in FIGS. 3A through 3C, the user may open a menu (“MENU”) 134 displayed by the display 112 of the digital camera 100 (FIG. 1) and select a menu option 136 to enable audio annotation file naming (e.g., by selecting the check box 138 next to the menu option 136 “Enable Voice Annotation File Naming” as shown in FIGS. 3B and 3C) initiating the speech-to-text conversion engine 128. The speech-to-text conversion engine 128 searches or scans through digital image files 122 stored in memory 110 of the digital camera 100 for those digital image files 122 having audio annotations 124, and automatically converts the audio information contained in the audio annotation 124 for each digital image file 122 having an associated audio annotation 124 to a text string 130 using a speech-to-text conversion routine. The speech-to-text conversion engine 128 then replaces the default filenames 126 of the digital image files 122 with the text string 130 and stores the digital image file 122 in memory 110 so that the text string 130 is associated with the digital image file 122 as the annotated filename 132 of the digital image file 122.

In FIGS. 3A through 3C, digital image files 122 are represented by thumbnails 140 having initial default filenames 126 “DSC0111,” “DSC0112,” “DSC0113,” “DSC0114,” “DSC 0115” and “DSC0116.” Those digital image files 122 having associated audio annotations 124 are indicated by an icon 142 such as a speaker icon, note icon, or the like. Thus, in FIGS. 3A through 3B, digital image files 122 with filenames “DSC0111,” “DSC0113” and “DSC 0115” have associated audio annotations 124 which contain the audio information, which the speech-to-text conversion engine 128 converts into the text strings “Text String,” “Text String 2,” and “Text String 3,” respectively. The speech-to-text conversion engine 128 then replaces the initial default filenames “DSC0111,” “DSC0113” and “DSC 0115” of the digital image files 122 containing audio annotations 124 with the annotated filenames “Text String,” “Text String 2,” and “Text String 3,” respectively, and stores the files 122 to memory 110. For example, a user may utilize the digital camera 100 to take digital photographs during a camping trip which are stored as digital image files 122. After taking digital photographs of a companion setting up the campsite and standing next to a lake, the user may record audio annotations 124 containing audio information such as “Jane by the lake” and “Setting up camp,” which are associated with the digital image files 122 and stored in memory 110 under the initial default filenames 126 “DSC0111” and “DSC0113,” respectively. When the user selects the “Enable Voice Annotation File Naming” menu option 136, the speech-to-text conversion engine 128 converts the audio information “Jane by the lake” and “Setting up camp” into suitable text strings 130 such as “Janebythelake” and “Settingupcamp” and replaces the initial default filenames 126 “DSC0111” and “DSC0113” with the text strings 130 “Janebythelake” and “Settingupcamp” so that the digital image files 122 are renamed with the annotated filenames 132 “Janebythelake” and “Settingupcamp,” respectively. It will be appreciated that when the digital image files are downloaded to an image processing device (see FIG. 9), the annotated filenames may be further modified, for example, by adding a file extension such as “.JPG,” “.TIF” or the like.

In embodiments of the invention, where two or more digital image files 122 have audio annotations 124 containing audio information that is sufficiently similar that the speech-to-text conversion engine 128 converts the audio information into identical text strings 130, the speech-to-text conversion engine 128 may assign a sequence indicator to the text string 130 prior to associating the text string 130 with the digital image file 122 as the annotated filename 132 of the digital image file 122. Thus, in the example provided wherein the user utilizes the digital camera 100 to take digital photographs of a companion standing beside a lake, the user may take two or more digital photograph of the companion setting up the campsite and record audio annotations 124, each of which contain the audio information “Jane by the lake” so that the speech-to-text conversion engine 128 converts the audio information “Jane by the lake” into identical text strings 130 “Janebythelake.” Upon determining that the two text strings are identical, the speech-to-text conversion engine 128, or associated software, may then add a sequence identifier to one or more of the text strings 130. For example, the speech-to-text conversion engine may add the sequence numbers “1” and “2” to create the text strings 130 “Janebythelake1” and “Janebythelake2” providing the annotated filenames 132 “Janebythelake1” and “Janebythelake2,” respectively.

FIG. 4 summarizes a method 200 for generating an annotated filename for a digital image file, which may be used by the digital camera 100 shown in FIGS. 1 and 2, in accordance with an exemplary embodiment of the present invention. An image or images are captured by the imaging system 102 of the digital camera 100, at step 202; a digital image file 122 is created, at step 204. Audio information associated with the image is next recorded, at step 206, and used to generate an audio annotation 124, at step 208, which is associated with the digital image file 122. For instance, as described in the discussion of FIGS. 3A through 3C, after a photographic image is captured, the digital camera 100 may prompt the user to record an audio annotation 126. The digital image file 122 and associated audio annotation 124 are then assigned an initial default filename using a suitable default file naming scheme and stored in memory 110, at step 210, indexed by the initial default filename. The user may, at any time after the digital image file 122 and audio annotation 124 are stored in memory 110, choose to create an annotated filename for digital image files 122 stored in memory 110 of the digital camera 100 using the audio annotations 124 associated with the digital image file 122, at step 212. For example, as described in the discussion of FIGS. 3A through 3C, the user may open a menu (“MENU”) 134 displayed by the display 112 of the digital camera 100 (FIG. 1) and select a menu option 136 to enable audio annotation file naming. If the user chooses not to enable audio annotation file naming, additional digital images 122, and optionally audio annotations 124 may be captured by repeating steps 202 through 210. However, if the user chooses to enable audio annotation file naming in step 212, for example, by selecting the “Enable Voice Annotation File Naming” menu option 136 as described in the discussion of FIGS. 3A through 3C, the audio information of audio annotations 124 then stored in memory 110 is converted to a text string 130, at step 214, and associated with the digital image file 122, at step 216, as the annotated filename 132 of the digital image file 122. The renamed digital image file 122 may then be stored to memory 110 or alternatively, transmitted to a digital image processing device, such as a computer, photographic printer, or the like, at step 218. Where two or more digital image files 122 have audio annotations 124 containing audio information that is sufficiently similar that the speech-to-text conversion engine 128 converts the audio information into identical text strings 130, a sequence indicator may be assigned to one or more of the text string 130 prior to associating the text string 130 with the digital image file 122 as the annotated filename 132 of the digital image file 122.

It will be appreciated that, once audio annotation file naming has been enabled and any digital image files 122 having associated audio annotations 124 stored in memory 110 are renamed to have annotated filenames 132, additional images may be captured and stored as digital image files 122 by the digital camera 100. In such instances, these digital image files 122 may be provided with initial default filenames 126 and thereafter renamed with annotated filenames 132 as described in the discussion of the embodiments illustrated in FIGS. 1 through 4. Alternatively, these digital image files 122 (i.e., the digital image files 122 created after audio annotation file naming is initiated) may be provided with annotated filenames 132 without first being assigned initial default filenames 126 as described in the discussion of the embodiment of the invention shown in FIGS. 5 through 8. In such embodiments, if, once audio annotation file naming has been enabled, an image or images are captured and a digital image file 122 is generated, but no audio annotation 124 is recorded (e.g., the user fails to record a voice annotation after being prompted to do so) the processing system 108 may assign a default filename 126 (e.g., “DSC0116,” or the like) to the digital image file 122 created. Depending on user settings, or the like, the processing system 108 may continue to prompt the user to record an audio annotation 124 when subsequent digital image files 122 are thereafter created for providing audio annotation file naming, or, alternative, may default to a conventional file naming scheme by assigning an initial default file name 126.

Referring now to FIGS. 5 through 8, the digital camera 100 may further allow annotated filenames 132 to be generated for digital image files 122 without first assigning initial default filenames 126. As shown in FIG. 5, the digital camera 100 illustrated in FIG. 1, may further include a temporary buffer memory 144 coupled to the processing system 108 of the digital camera 100 for temporarily storing audio annotations 124 recorded by the digital camera via the audio system 114. In exemplary embodiments, the temporary buffer memory 144 may comprise Random Access Memory (RAM) of the processing system 108 of the digital camera 100, a separate RAM memory, a FLASH memory, or the like. Alternately, the temporary buffer memory 144 may comprise a partitioned section of memory 110.

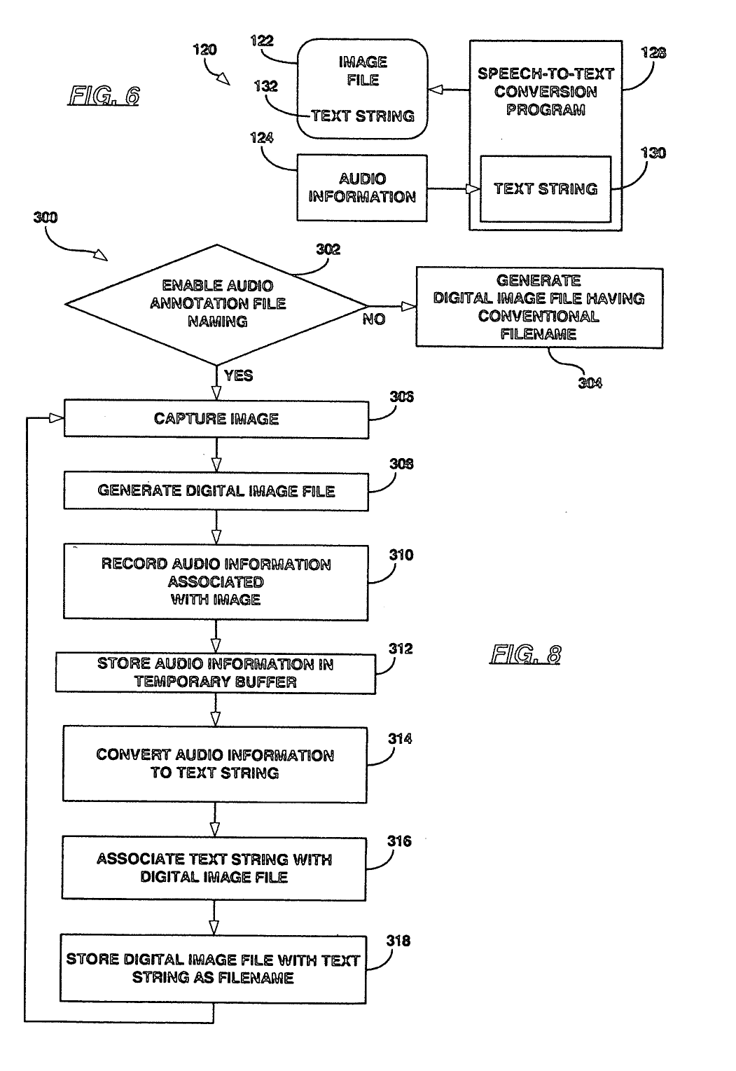

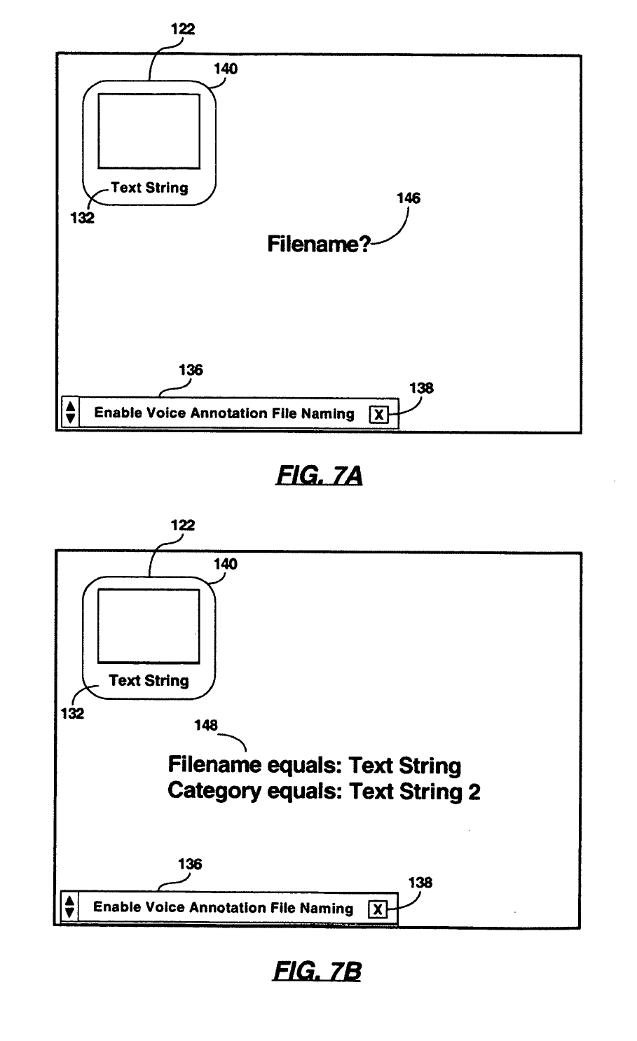

FIG. 6 illustrates a system 120, employed by the digital camera 100 shown in FIG. 5, for automatically generating annotated filenames for digital image files in accordance with an exemplary embodiment of the present invention. In this embodiment, an image or images (e.g., a photograph, digital video, or the like) are captured by the imaging system 102 of the digital camera 100 to be stored in memory 110 as a digital image file 122. An audio annotation 124 associated with the digital image file 122 may then be generated by recording audio or voice information using the audio system 114 of the digital camera 100. For instance, in the embodiment shown in FIG. 7A, after a photographic image is captured, the digital camera 100 may prompt the user (e.g., via a prompt 146 such as “Filename?” or the like, displayed by the display 112 shown in FIG. 7A) to record an audio annotation 124.

The user may then speak into the microphone 116 of the audio system 114 to record an audio annotation 124, which is typically a few seconds in duration. When recorded, the audio annotation is temporarily stored in the temporary buffer memory 144. The speech-to-text conversion engine 128 automatically converts the audio information contained in the audio annotation 124 stored in the temporary buffer memory 144 to a text string 130 using a speech-to-text conversion routine. The speech-to-text conversion engine 128 then stores the digital image file 122 in memory 110 so that the text string 130 is associated with the digital image file 122 as the annotated filename (e.g., “Text String”) 132 of the digital image file 122. If desired, the audio annotation 124 may also be saved to memory 110 and associated with the digital image file 122. The temporary buffer memory 144 may then be cleared or erased. Alternatively, the temporary buffer memory 144 may retain the audio annotation 124 until a second audio annotation 124 is recorded and written over the first audio annotation 124 in the temporary buffer memory 144. For example, a user may utilize the digital camera 100 to take digital photographs during a camping trip which are stored as digital image files 122. After taking a digital photograph of a companion setting up the campsite, the user may record an audio annotation 124 containing audio information such as “Setting up camp,” which stored in the temporary buffer memory 144. The speech-to-text conversion engine 128 converts the audio information “Setting up camp” into a suitable text string 130 such as “Settingupcamp” which is associated with the digital image files 122 as the annotated filename 132 “Settingupcamp.” It will be appreciated that when the digital image files are downloaded to an image processing device (see FIG. 9), the annotated filenames may be further modified, for example, by adding a file extension such as “.JPG,” “.TIF” or the like.

Alternatively, the speech-to-text conversion engine 128 may receive and recognize commands input via the display or the audio system 114 using a defined voice grammar for file naming prior to recording of the audio annotation 124. In this embodiment, a user may input a command by speaking a predefined keyword or phrase (parroted by the display 112 as phrase 148 for purposes of illustration) followed by the audio information of the audio annotation 124 into the microphone 116 of the audio system 114. Thus, as shown in FIG. 7B, the user, after capturing an image and generating a digital image file 122 may speak one or more keyword phrases such as “Filename equals” or “Category equals” followed by appropriate audio annotations 124 which are then stored in the temporary buffer memory 144 and converted to a text string 130 and used for generation of the annotated file name 132 associated with the digital image file 122, which may include a category folder in which the digital image file 122 is stored, or the like. Alternatively, the user may speak the keyword phrases before the image is captured and the digital image file 122 generated.

Again, in embodiments of the invention where two or more digital image files 122 have audio annotations 124 containing audio information that is sufficiently similar that the speech-to-text conversion engine 128 converts the audio information into identical text strings 130, the speech-to-text conversion engine 128, or associated software, may assign a sequence indicator to the text string 130 prior to associating the text string 130 with the digital image file 122 as the annotated filename 132 of the digital image file 122. Thus, in the example provided wherein the user utilizes the digital camera 100 to take digital photographs during a camping trip, the user may take two or more digital photographs of the companion setting up the campsite and record audio annotations 124, each of which contain the audio information “Jane by the lake” so that the speech-to-text conversion engine 128 converts the audio information “Jane by the lake” into identical text strings 130 “Janebythelake.” Upon determining that the second text string is identical to the annotated file name of a digital image file 122 stored in memory 110, the speech-to-text conversion engine 128, or associated software, may add a sequence identifier to the text string 130 prior to generating the annotated filename for the second digital image file 122. For example, the speech-to-text conversion engine may add the sequence numbers “1” and “2” to create the text strings 130 “Janebythelake1” and “Janebythelake2” providing the annotated filenames 132 “Janebythelake1” and “Janebythelake2,” respectively.

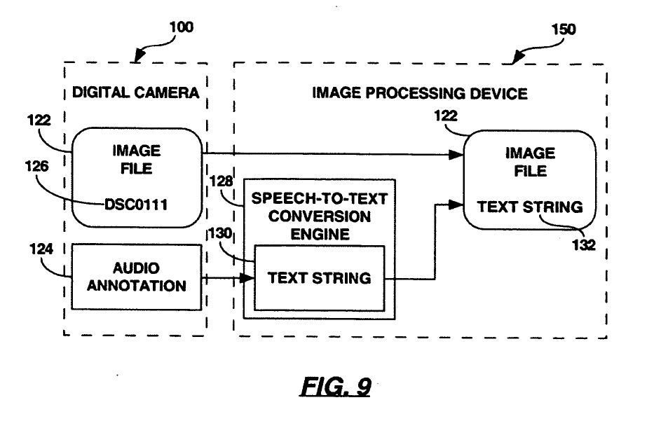

FIG. 8 summarizes a method 300 for generating an annotated filename for a digital image file, which may be used by the digital camera 100 shown in FIGS. 5 and 6, in accordance with an exemplary embodiment of the present invention. First, a determination is made whether audio annotation file naming has been enabled for the digital camera 100, at step 302. If audio annotation file naming has not been enabled, conventional default filenames are generated and associated with digital image files 122 containing images captured by the digital camera 100, at step 304. However, once audio annotation file naming is enabled, at step 302, annotated filenames are created for digital image files 122 generated by the digital camera 100. An image or images are captured by the imaging system 102 of the digital camera 100, at step 306, and a digital image file 122 is created, at step 308. Audio information associated with the image is next recorded, at step 310, and used to generate an audio annotation 124 which is stored in the temporary buffer memory 144, at step 312. For instance, as described in the discussion of FIGS. 7A and 7B, after a photographic image is captured, the digital camera 100 may prompt the user to record an audio annotation 124, or, alternatively, as described in the discussion of FIG. 7C, the user may enter a voice keyword or phrase command via the followed by the audio annotation 124. The audio information of the audio annotation 124 is then converted to a text string 130, at step 314, and associated with the digital image file 122, at step 316, as the annotated filename 132 of the digital image file 122. The digital image file 122 may then be stored to memory 110 or alternatively, transmitted to a digital image processing device, such as a computer, photographic printer, or the like, at step 318. Were a second digital image file 122 to have an audio annotation 124 containing audio information that is sufficiently similar that the speech-to-text conversion engine 128 converts the audio information into identical text strings 130, a sequence indicator may be assigned to the text string 130 prior to associating the text string 130 with the digital image file 122 as the annotated filename 132 of the digital image file 122.

In the embodiments illustrated in FIGS. 5 through 8, if an image or images are captured so that a digital image file 122 is generated but no audio annotation 124 is recorded (e.g., the user fails to record a voice annotation after being prompted to do so), the processing system 108 may assign a default filename 126 (e.g., “DSC0116,” or the like) to the digital image file 122 created. Depending on user settings, or the like, the processing system 108 may continue to prompt the user to record an audio annotation 124 when subsequent digital image files 122 are thereafter created for providing audio annotation file naming, or, alternative, may default to a conventional file naming scheme by assigning an initial default file name 126.

In the embodiments illustrated in FIGS. 1 through 8, the present invention employs a speech-to-text conversion engine 128 implemented as a set of instructions (e.g., a software program, firmware, or the like) executed by the processing system 108 of the digital camera 100. However, it will be appreciated that the present invention is not necessarily limited to this implementation. For example, in the embodiment illustrated in FIG. 9, the speech-to-text conversion engine 128 is implemented as a set of instructions implemented by the processing system of an image processing device 150 such as a personal computer, digital image printer, or the like. In this embodiment, a digital image file 122 having an associated audio annotation 124 is given an initial default filename 126 and stored in memory 110 of the digital camera 100. The digital image file 122 and associated audio annotation 124 may then be transferred to the image processing device 150 (e.g., by transmitting the digital image file 122 and audio annotation 124 via a connection such as a Universal Serial Bus (USB) connection, FireWire (IEEE 1394) connection, or the like, or by removing the memory 110 of the digital camera 100 and transferring it to the image processing device 150. Once transferred, a speech-to-text conversion engine 128 resident in the image processing device 150 automatically converts the audio information contained in the audio annotation 124 to a text string 130 using a speech-to-text conversion routine. The speech-to-text conversion engine 128 then replaces the default filename 126 of the digital image file 122 with the text string 130 and stores the digital image file 122 so that the text string 130 is associated with the digital image file 122 as the annotated filename 132 of the digital image file 122.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not necessarily meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A digital camera, comprising:
an imaging system for capturing an image;
a processing system coupled to the imaging system for processing the captured image as a digital image file; and
an audio system coupled to the processing system for acquiring an audio annotation, the audio annotation containing audio information associated with the digital image file,
wherein the processing system executes a program of instructions for converting the audio information to a text string and associating the text string with the digital image file as an annotated filename of the digital image file stored in the memory.

2. The digital camera as claimed in claim 1, wherein the program of instructions executed by the processing system assigns an initial default filename to the digital image file and replaces initial filename with the annotated filename.

3. The digital camera as claimed in claim 1, wherein the program of instructions executed by the processing system receives a command inputted via the audio system prior to recording the audio annotation, the command indicating that the audio information is to be converted to the text string associated with the digital image file as the annotated filename.

4. The digital camera as claimed in claim 3, wherein the command comprises an audio command.

5. The digital camera as claimed in claim 1, wherein the program of instructions further adds a sequence indicator to the text string prior to associating the text string with the digital image file as the annotated filename of the digital image file.

6. The digital camera as claimed in claim 1, further comprising a memory for storing the digital image file and the audio annotation.

7. The digital camera as claimed in claim 1, further comprising a temporary buffer memory for storing the audio annotation.

8. The digital camera as claimed in claim 7, wherein the program of instructions causes the temporary buffer memory to be emptied after the text string is associated with the digital image file.

9. A method for generating an annotated filename for a digital image file, comprising:
acquiring an audio annotation, the audio annotation containing audio information associated with the digital image file;
converting the audio information to a text string using a speech-to-text conversion program; and
associating the text string with the digital image file as the annotated filename of the digital image file.

10. The method as claimed in claim 9, further comprising capturing the digital image file and storing the digital image file in memory.

11. The method as claimed in claim 9, wherein the digital image file has an initial default filename, the initial default filename being replaced by the annotated filename.

12. The method as claimed in claim 9, further comprising receiving a command prior to recording the audio annotation, the command indicating that the audio information is to be converted to the text string associated with the digital image file as the annotated filename.

13. The method as claimed in claim 12, wherein the command comprises an audio command.

14. The method as claimed in claim 9, wherein acquiring an audio annotation comprises recording an audio annotation.

15. The method as claimed in claim 14, further comprising:
capturing a second digital image file;
storing the second digital image file in memory:
recording a second audio annotation, the audio annotation containing audio information associated with the second digital image file, wherein the audio information associated with the second digital image file is substantially similar to the audio information associated with the first digital image file;
converting the audio information associated with the second digital image file to a second text string using a speech-to-text conversion program;
adding a sequence indicator to the second text string; and
associating the second text string with the second digital image file as the annotated filename of the second digital image file.

16. The method as claimed in claim 14, wherein recording the audio annotation comprises storing the audio annotation in memory.

17. The method as claimed in claim 14, wherein recording the audio annotation comprises storing the audio annotation in a temporary buffer memory.

18. The method as claimed in claim 17, further comprising emptying the temporary buffer memory after the text string is associated with the digital image file.

19. A system for generating a filename for a digital image file, comprising:
means for acquiring an audio annotation, the audio annotation containing audio information associated with the digital image file;
means for converting the audio information from the audio annotation to a text string using a speech-to-text conversion program; and
means for associating the text string with the digital image file as the filename of the digital image file.

20. The system as claimed in claim 19, further comprising means for capturing the digital image file and storing the digital image file in memory.
